(19) United States
(12) Patent Application Publication
(10) Pub. No.: US 2005/0052016 A1
(43) Pub. Date: Mar. 10, 2005

(54) Binding element

(76) Inventor: Guido Peleman, Puurs (BE)

Correspondence Address: BACON & THOMAS, PLLC, 625 SLATERS LANE, FOURTH FLOOR, ALEXANDRIA, VA, 22314, US

(21) Appl. No.: 10/935,090

(22) Filed: Sep. 8, 2004

(30) Foreign Application Priority Data
Sep. 9, 2003 (BE) 2003/0487

(51) Int. Cl. B42D 1/00

(52) U.S. Cl. 281/21.1

(57) ABSTRACT

Improved binding element which mainly consists of a rigid back (2) defining a space (3) provided with a layer of glue (4) on the inside and in which, in order to bind leaves (7), these leaves can be provided with one edge, characterized in that on this back (2) is provided a strip (5) made of material that can be perforated.

### BACKGROUND OF THE INVENTION

1. Field of the Invention

The present invention concerns an improved binding element, more particularly of the type which consists of a rigid back defining a space provided with a layer of glue on the inside and in which, in order to bind leaves, these leaves can be provided with one edge.

2. Discussion of the Related Art

In order to bind the leaves, the back is provided in a suitable binding appliance together with the leaves so as to heat the binding element up to a temperature whereby the glue becomes liquid and is spread around the above-mentioned edge of the leaves, after which the binding element with the leaves is left to cool in order to make the glue cure and to obtain a bound bundle in this manner whose leaves are firmly glued in the back.

A disadvantage of such a bundle is that it is difficult to classify it in ring binders or the like, since in such a bundle, especially in the case of thick bundles, it is difficult to make perforations through the bundle.

Another disadvantage is that perforated bundles are difficult to shift over the roundings of the rings, especially when the bundle concerned has a certain thickness.

### SUMMARY OF THE INVENTION

The present invention aims to provide a solution to the above-mentioned and other disadvantages by providing an improved binding element of the above-mentioned type, which is equipped with a strip with which the bundle can be easily and simply stored in a ring binder.

To this end, the invention concerns an improved binding element of the above-mentioned type which mainly consists of a rigid back defining a space which is provided with a layer of glue on the inside and in which, in order to bind leaves, these leaves can be provided with one edge, whereby a strip is provided on said back made of material that can be perforated.

An advantage of an improved binding element according to the invention is that the above-mentioned strip can be provided with suitable perforations in order to make it possible, after the leaves have been bound, to provide the obtained bundle in a ring binder, whereby the bundle can moreover easily revolve over the rings.

The strip is preferably made of a flexible material, such as plastic, cardboard or the like, or it is provided with a folding line, such that the strip can be placed against the leaves to be bound when the back, before the binding, is placed in the binding appliance, to thus not form any hindrance when the back is being heated.

After the binding, the strip is folded back, such that it protrudes from the bundle over a certain width, whereby this protruding part is then provided with the necessary perforations, such that the bundle with the perforated strip can be classified in a ring binder or the like in this manner.

### BRIEF DESCRIPTION OF THE DRAWINGS

In order to better explain the characteristics of the invention, the following preferred embodiments of an improved binding element according to the invention, are described as an example only without being limitative in any way, with reference to the accompanying drawings in which:

FIG. 1 schematically represents a binding element according to the invention in perspective;

FIG. 2 represents a section according to line II-II in FIG. 1 to a larger scale;

FIG. 3 represents a section of a binding element according to the invention while the leaves are being bound with a binding appliance;

FIG. 4 represents a section similar to that in FIG. 2., but for a bound bundle of leaves;

FIG. 5 represents a bound bundle of leaves in perspective, provided in a ring binder;

FIG. 6 represents a section as in FIG. 2, but for a variant.

### DISCRIPTION OF THE PREFERRED EMBODIMENT

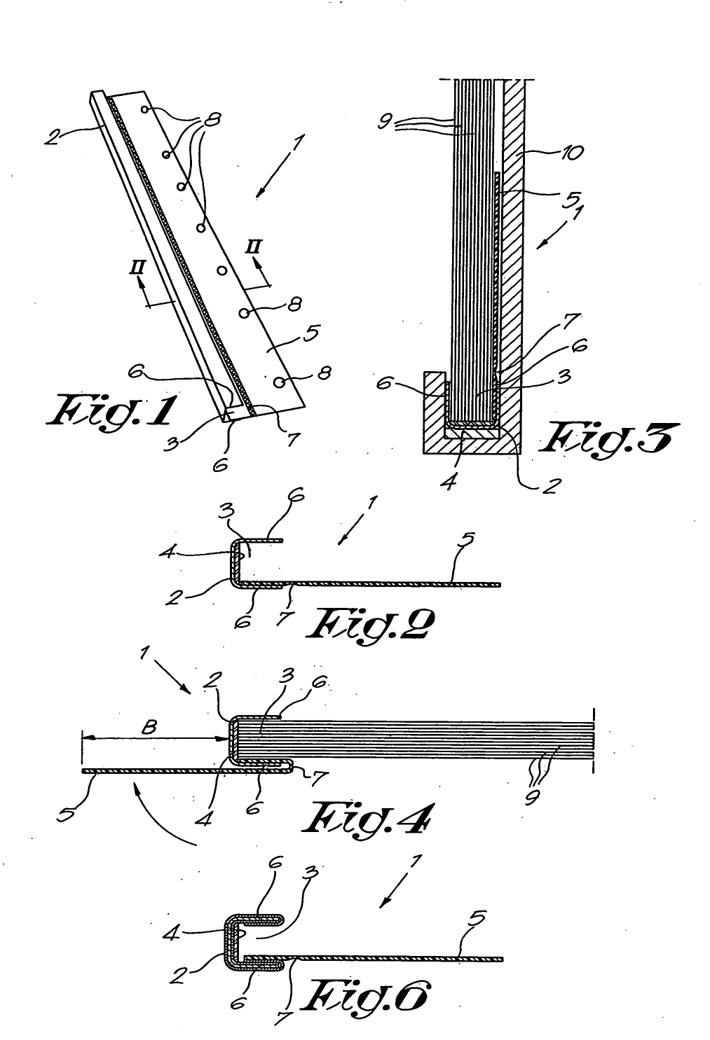

FIGS. 1 and 2 represent an improved binding element 1 according to the invention which mainly consists of a rigid back 2, for example made of metal, which is made U-shaped in the given example and which defines a space 3, the inside of which, in this case more particularly the bottom, is provided with a layer of glue 4, whereby this layer of glue 4 is such that it will melt when it is sufficiently heated, and can cure when being cooled.

According to the invention, the binding element 1 is provided with a strip 5 made of material that can be perforated, for example plastic, cardboard or the like, which is fixed with one edge in the longitudinal direction of the back 2 onto said back 2, for example on the inside of one of the parallel walls 6 of the U-shaped back 2.

The strip 5 is preferably fixed on the back 2 by means of a glue whose melting temperature is higher than that of the above-mentioned layer of glue 4.

In the given example, at a short distance, next to the free edge of a wall 6, is provided a folding line 7 in the longitudinal direction of the strip 5, which folding line 7 is realized for example by means of a reduced thickness of the strip 5, by means of perforations, or the like.

In de strip 5, at regular distances from each other, are provided perforations 8 with which the strip 5 can be provided in a ring binder or the like.

The use of the binding element 1 according to the invention is very simple and as follows.

In order to bind a bundle of leaves 9, these leaves 9 are provided with one edge in the space 3 of the back 2 up against the layer of glue 4, whereby the strip 5 is in this case situated against the bundle of leaves 9.

The thus obtained bundle, as represented in FIG. 3, is provided with its back 2 in a binding appliance 10 designed for it, with which the back 2 can be heated up to a temperature at which the layer of glue 4 melts.

The edges of the leaves 9 thereby sink in the layer of glue 4, such that, after the cooling, the cured layer of glue 4 forms a rigid glued joint between the leaves 9 and the back 2.

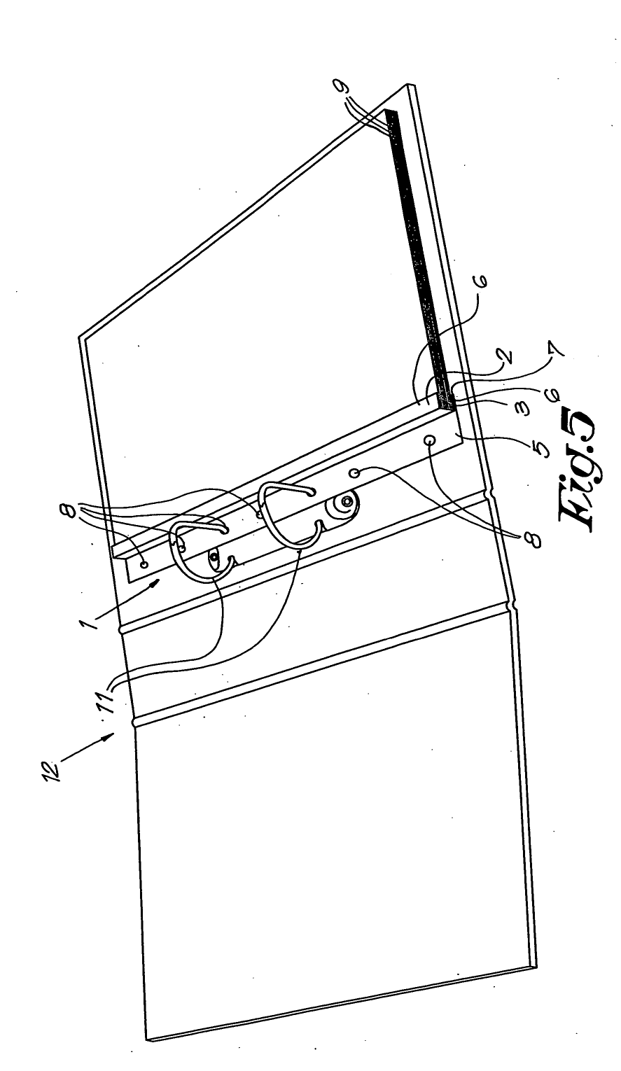

After the binding of the leaves 9, the strip 5 is folded down such that, as represented in FIG. 4, it protrudes from the bundle over a certain width B, whereby this width B is sufficient for the perforations 8 of the strip to be sufficiently free so as to be able to provide the strip 5, as represented in FIG. 5, with its perforations 8 over the rings 11 of a ring binder 12 or the like.

Thus, a bound bundle can be classified in a very simple and orderly manner.

It is clear that the perforations in the strip 5 must not necessarily be provided beforehand, but that they can also be provided after the binding.

FIG. 6 represents a variant of a binding element according to the invention, whereby in this case the back 2 is provided with decorative or protective coating 13.

The present invention is by no means limited to the above-described embodiments given as an example and represented in the accompanying drawings; on the contrary, such an improved binding element according to the invention can be made in all sorts of shapes and dimensions while still remaining within the scope of the invention.

1. A binding element comprising a rigid back defining a space provided with a layer of glue on the inside and in which, in order to bind leaves, the leaves are provided with one edge, wherein on said back is provided a strip made of material that can be perforated.

2. The binding element according to claim 1, wherein the strip is fixed with one edge to said back in the longitudinal direction of the back.

3. The binding element according to claim 1, wherein the strip is fixed with one edge to the inside of the back.

4. The binding element according to claim 1, wherein the back is made U-shaped with two parallel walls and wherein the strip is fixed with one edge onto one of these walls.

5. The binding element according to claim 1, wherein the strip is made of a flexible material.

6. The binding element according to claim 1, wherein the strip is made of synthetic material.

7. The binding element according to claim 1, wherein the strip is provided with a folding line in the longitudinal direction.

8. The binding element according to claim 7, wherein said folding line is located at a short distance from a free edge of the back.

9. The binding element according to claim 1, wherein the strip is provided with suitable perforations which make is possible to fix the binding element with bound leaves in a ring binder.

10. The binding element according to claim 1, wherein the back is made of metal.
